(19) United States
(12) Patent Application Publication
(10) Pub. No.: US 2007/0218894 A1
(43) Pub. Date: Sep. 20, 2007

(54) Method and apparatus for conveying pre-stored resource information to a radio access network

(76) Inventors: John M. Harris, Chicago, IL (US); Ronald T. Crocker, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 11/384,707

(22) Filed: Mar. 20, 2006

(51) Int. Cl. H04Q 7/20

(52) U.S. Cl. 455/426.1

(57) ABSTRACT

A system includes a mobile station [105] transmits identifying information relating to the mobile station [105]. A radio access network [115] receives the identifying information from the mobile station [105]. A server [120] in communication with the radio access network [115] associates the identifying information with a predetermined function. A transmission element [145] performs the predetermined function in response to the associating of the identifying information with the predetermined function.

### TECHNICAL FIELD

This invention relates generally to the quick transmission of pre-stored resource information from a mobile station to a radio access network with minimal bandwidth.

### BACKGROUND

In current wireless systems, a relatively large amount of bandwidth is utilized during an initialization process when a mobile station desires to, e.g., invite another mobile station to engage in a Push To Talk (“PTT”) or another mobile-to-mobile communication. That is, several messages must initially be transmitted between a radio access network and the mobile station before a packet or other data can be sent to a target mobile station.

For example, in an Orthogonal frequency-division multiplexing (“OFDM”) wireless system, the mobile station transmits an initial ranging code to the radio access network when it desires to transmit a packet of data such as, e.g., an invitation to engage in a PTT communication with the target mobile station. The initial ranging code can be randomly selected by the mobile station. In response to receipt of the initial ranging code, the radio access network sends to the mobile station a short assignment, i.e., an assignment just large enough for the mobile station to indicate its name and how many bytes it wants to transmit, and possibly some additional information such as authentication information.

After receiving this reply from the radio access network, the mobile station transmits its identity, i.e., its name, how many bytes it wants to transmit, and possibly some additional information such as the authentication information such as a password. In response to receipt of this information, the radio access network sends an assignment to the mobile station. For example, the assignment might be an allocation of a specified number of bytes starting at a specific time or a set duration of time. Finally, the mobile station sends a packet according to the assignment.

This method, however, is costly in terms of time expended and bandwidth utilized due to the various data transmitted back and forth between the mobile station and the radio access network prior to a packet, such as an invite to a PTT session, being transmitted to the target mobile station.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system according to an embodiment of the invention;

FIG. 2 illustrates a method of determining an identity of the first mobile station and a requested function according to an embodiment of the invention;

FIG. 3 illustrates a method of determining a function to be implemented based on information provided by the first mobile station according to an embodiment of the invention; and

FIG. 4 illustrates a method of providing associations between various combinations of unique identifiers and functions to be performed according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a system, method, and apparatus are provided that allow for a faster transmission of critical resource information from a mobile station to a radio access network or any other type of wireless network with minimal bandwidth. The mobile station may provide a server of or in communication with the radio access network with a list of pre-selected triggering events that will cause the radio access network to, e.g., transmit a pre-selected packet to a target device such as a target mobile station.

The mobile station may comprise a cellular telephone. Upon power up, the mobile station may transmit to the server a list of the triggering events and the associated packets to be transmitted or other actions to implement upon detection of one of the triggering events. The triggering events may comprise a unique combination of certain characteristics of a communication from the mobile station to the radio access network such as a pre-selected initial ranging code, a pre-selected bandwidth request size, a pre-selected timing offset, a pre-selected base station location, a pre-selected time of day, a pre-selected timing for the initial ranging code, use a pre-selected media access control (“MAC”) Identifier (“ID”), a detection of a page response, a detection of a registration, use of a pre-selected frequency band, and detection that the radio access network has received a pre-selected packet.

The predetermined function may comprise at least one of a transmission of a first pre-selected packet between the radio access network and the mobile station, transmission of a second pre-selected packet from the radio access network to a network, a deletion of a third pre-selected packet, an establishment of a first radio link, and a termination of a second radio link.

Accordingly, the mobile station may program the radio access network to implement a “macro,” a pre-selected combination of criteria that instruct the radio access network to perform some act. By utilizing such macros, the mobile station can more quickly enter into a Push To Talk (“PTT”) or other mobile-to-mobile communication with a target mobile station.

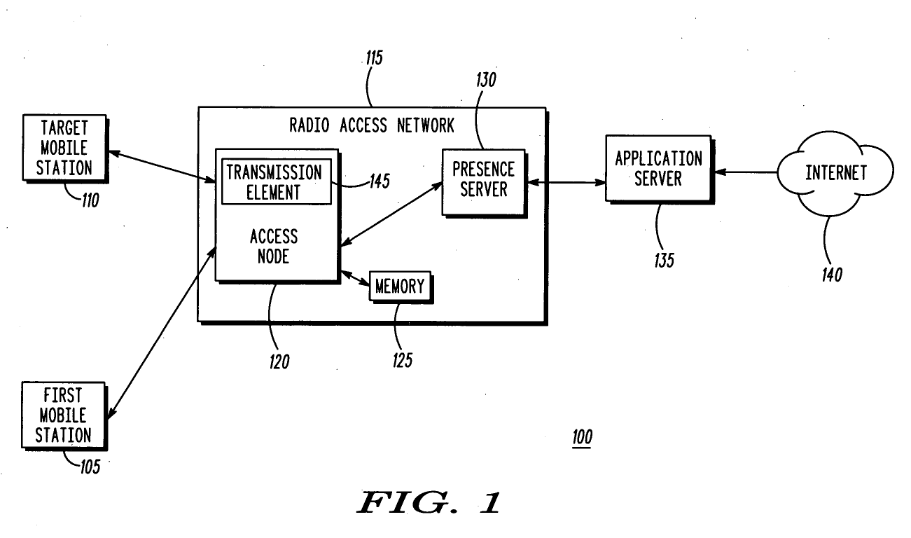

FIG. 1 illustrates a system 100 according to an embodiment of the invention. As shown, the system 100 includes a first mobile station 105 and a target mobile station 110. In the event that the first mobile station 105 is powered on or wakes up from a sleep mode, the first mobile station 105 may transmit a set of pre-selected triggering events and pre-selected actions to be implement upon detection of any of the pre-selected triggering events to a radio access network 115, as discussed below with respect to FIG. 4. The radio access network 115 may include an access node 120, a memory 125, and a presence server 130. Although an access node 120 is shown in FIG. 1, it should be appreciated that a broadcast server, Push-to-Talk over Cellular (“PoC”) server, base station, or packet control functionality module may instead be utilized in addition to, or instead of, the access node 120.

The access node 120 is in communication with the memory 125. When a set of pre-selected triggering events and pre-selected actions to be implemented upon detection of any of the pre-selected triggering events is transmitted from the mobile station to the radio access network 115, this information is received by the access node 120 and may then be stored in the memory 125. For example, this information may be stored in the memory 125 as a lookup table. The access node 120 is also in communication with a presence server 130. Although shown as being contained within the radio access network 115 in FIG. 1, it should be appreciated that the presence server 130 may be located outside of the radio access network 115 in other embodiments. The presence serves 130 may store the present state of the first mobile station 105, as well as the states of other devices such as the target mobile station 110. These states are useful for Instant Messaging. The various types of states stored in the presence server 130 include “on the phone,” “in a meeting,” and other various expressions for indicating whether a user of a particular mobile station is available to receive a call or engage in PTT or some other mobile-to-mobile communication. In other words, a state is an attribute that describes information about the mobile station to make it easier for another mobile station to decide whether to call the mobile station.

The presence server 130 may be in communication with an application server 135. The application server 135 may be in communication with the Internet 140 or some other network. The application server 130 may be utilized to transmit a packet for the first mobile station 105. The application server 135 may learn of a Radio Frequency (“RF”) event from at least one of a presence source within the radio access network 115, such as the presence server 130, or a signaling message transmitted from the radio access network 115.

In the event that the presence server 130 is updated with a state for a device, this state information may be published, i.e., pushed from the presence server 130 to the application server 135. The state information may also be transmitted across the Internet 140 to other applicable devices or networks.

The system 100 of FIG. 1 is utilized to quickly transmit critical or any other type of recurring information to a target mobile station 110. For example, in the event that a user of the first mobile station 105 desires to engage in a PTT or other mobile-to-mobile communication with the target mobile station 110, the radio access network 115 may be programmed to send, via a transmission element 145, an invitation packet to the target mobile station 110 after detecting a unique triggering event. For example, the first mobile station 105 may utilize a unique combination of codes, addresses, or technology for communicating with the radio access network 115. Based on this unique combination, the radio access network 115 may deduce what type of communication the first mobile station 105 desires to make as well as the identity of a desired target mobile station 110.

For example, the first mobile station 105 may transmit a unique initial ranging code that may be utilized to determine its identity and the type of information it would like to be sent to the target mobile station 110. When the first mobile station 105 powers on or awakens from a sleep mode and desires to transmit a packet or engage in a communication with the target mobile station 110, it must first let the radio access network 115 know that it is nearby. The reason why the initial ranging code is utilized is because the radio access network 115 does not initially know the identity of the first mobile station 105 or what the first mobile station 105 wants to do. Accordingly, the initial ranging code is transmitted. The initial ranging code may be randomly selected or a specified initial ranging code is utilized. The reason why the initial ranging code is transmitted instead of simply transmitting the entire packet right away is because the radio access network 115 functions more efficiently when mobile stations only communicate according to wireless assignments designated by the radio access network 115. The initial ranging code is not transmitted according to an assignment, however.

As discussed above, the initial ranging code may be utilized to determine the identity of the first mobile station 105 based on prior knowledge of the first mobile station 105. In some embodiments, however, only 256 or some other relatively finite number of different initial ranging codes may be utilized. Accordingly, in such embodiments, the initial ranging code by itself may not be sufficient to uniquely identify the first mobile station 105. Accordingly, this initial ranging code may be combined with other criteria to identify the first mobile station 105.

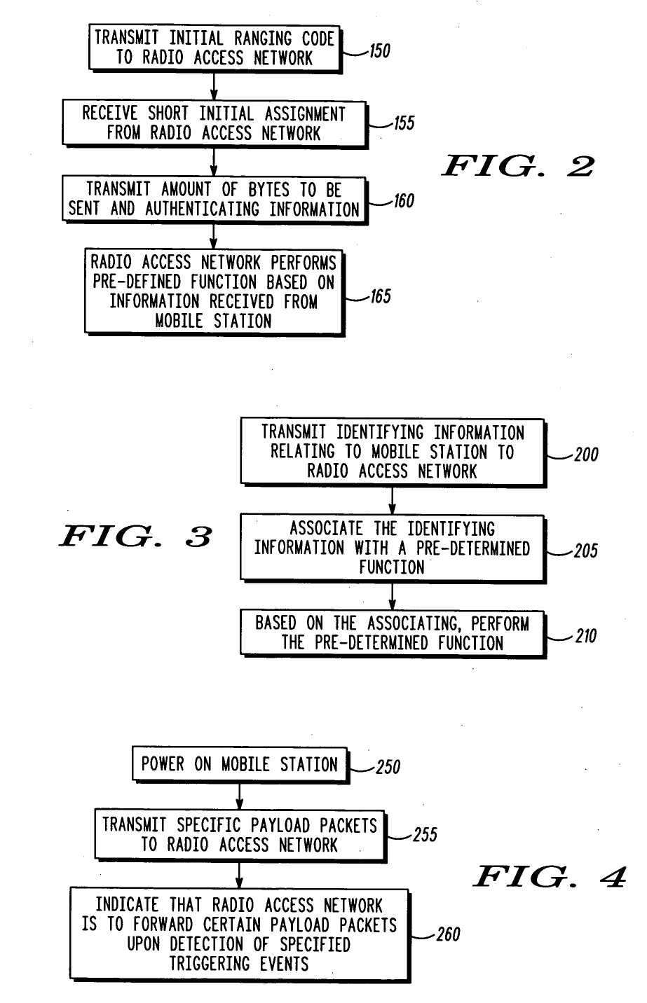

FIG. 2 illustrates a method of determining an identity of the first mobile station 105 and a requested function according to an embodiment of the invention. First, at operation 150, the first mobile station 105 transmits the initial ranging code to the radio access network 115. Upon receipt of the initial ranging code, the radio access network 115 transmits a short initial assignment that is received by the first mobile station 105 at operation 155. This short initial assignment may be just large enough for the first mobile station 105 to indicate its identity, i.e., its name, how many bytes it desires to transmit, and possibly also authentication information. Next, at operation 160, the first mobile station 105 transmits the amount of bytes to be sent as well as authenticating information in some embodiments. Finally, at operation 165, the radio access network performs a pre-defined function based on information received from the first mobile station 105. After the pre-defined function has been performed, the remote access network 115 may transmit a message to the first mobile device 105 to indicate that the pre-defined function was performed. For example, when a certain initial ranging code is utilized such as, e.g., code number “157,” the radio access network 115 may determine, based on a combination of this initial ranging code with other characteristics of the initial short communications from the first mobile station 105, what the first mobile station desires to do.

For example, if a combination of the initial ranging code “157” and some other characteristic are received, the radio access network 115 may determine that a PPT invite packet should be sent to the target mobile station 110. Accordingly, even though the first mobile station 105 has neither identified the target mobile station 110 nor transmitted the packet itself to the radio access network 115 at this time, the radio access network 115 is able to determine such information and transmit the packet, which may be pre-stored in the memory 125, to the target mobile station 110. By streamlining this process, the efficiency of the system 100 is greatly improved. Because the same type of mobile-to-mobile invitations may occur frequently, this method is utilized to more quickly identify what the first mobile station 105 desires to do and perform the desired function more quickly than would be possible if the actual packet itself and the identity of the target mobile station 110 had to be specifically provided by the first mobile station 105 each time the invitation is to be sent to the target mobile station 110. The invitation may also be sent to multiple target mobile stations. Also, in some embodiments, a call may be made to the target mobile station 110 instead of sending the invitation.

The additional identifying characteristics may include other criteria such as a timing offset used in transmitting the initial ranging code may also be used. For example, this timing offset, in combination with the actual value of the initial ranging code itself, may be utilized identify the target mobile station 105. In some embodiments, the method of FIG. 2 may be modified. For example, in some embodiments, the first mobile station 105 need not explicitly transmit its identity to the radio access network. Instead, the identity of the first mobile station 105 may be determined based on the defining characteristics of the initial communications with the radio access network 115.

Also, the amount of bytes requested at operation 160 may be utilized to determine the identity of the first mobile station 105, the second mobile station 110, or the function to be performed. The first mobile station 105 may include a unique Media Access Control (“MAC”) address which can be used to uniquely identify the first mobile station 105. A user may own several mobile stations and may utilize different ones to perform different functions. For example, the user may use one mobile station in a home office at the user's house, a second mobile station may be used solely at the user's place of work, and a third mobile station may be utilized solely in the user's automobile on the commute in to the user's place of work. Each of these mobiles stations may include a different MAC address that can be used to identify the mobile station being used. Alternatively, the user may store several different selectable MAC addresses on the first mobile station 1055. Based on a function the user desires to implement such as, e.g., a PTT communication with the target mobile station 110, the first mobile station 105 may automatically or the user may manually select the MAC address and, based on the chosen MAC address, the radio access network 115 may determine which function the user desires to implement with the first mobile station 105.

Another type of unique identifier is the timing of an access channel. For example, when the first mobile station 105 transmits the initial ranging code, the transmission of an odd numbered slot or channel may be representative of a certain function to be implemented. Also, the physical location of the first mobile station 105 when the initial ranging code is transmitted may also be utilized to indicate the identity of the first mobile station 105 and/or a function to be implemented. For example, if the user is at home when the initial ranging code is transmitted, it will be received by a different cellular sector than it would be received if the user were 20 miles away at the user's place of work.

The carrier band utilized when transmitting the initial ranging code may also be utilized to indicate the identity of the first mobile station 105 or a certain function to be implemented. Another type of indicator includes a determination of which radio access network 115 or cellular operator company for the first mobile station 105 to initiate a connection through.

Other types of indicators include a pre-selected time of day, a detection of a page response, a detection of a registration, use of a pre-selected frequency band, and detection that the radio access network 115 has received a pre-selected packet.

FIG. 3 illustrates a method of determining a function to be implemented based on information provided by the first mobile station 105 according to an embodiment of the invention. First, at operation 200, identifying information relating to the first mobile station 105 and/or a function to be performed is transmitted from the first mobile station 105 to the radio access network 115. The identifying information may include any combination of any of the various types of unique identifiers discussed above. Next, at operation 205, the identifying information is associated with a pre-determined function such as contacting the target mobile station 110 to implement a PTT communication or some other type of mobile-to-mobile communication. Finally, at operation 210, based on the association performed in operation 205, the predetermined function is performed. The predetermined function may include the transmission of certain packets or other information to the target mobile station 110 and the updating of the state of the first mobile station 105 in the presence server 130.

Other types of functions to perform include the transmission of a first pre-selected packet between the radio access network 115 and the target mobile station 110, transmission of a second pre-selected packet from the radio access network 115 to another network such as the Internet 140 or another radio access network. Additional functions include a deletion of a third pre-selected packet, an establishment of a first radio link, and a termination of a second radio link. According to a typical embodiment, the first packet is the next expected Transmission Control Protocol/Internet Protocol (“TCP/IP”) acknowledgment from the network, and the second packet is the next packet to be uploaded in a mobile station file upload.

The information relating to associations between various combinations of unique identifiers and functions to be performed may be initially provided by, e.g., the first mobile station 105 at power up or when the first mobile station 105 is awoken from a sleep mode. FIG. 4 illustrates a method of providing associations between various combinations of unique identifiers and functions to be performed according to an embodiment of the invention. First, at operation 250, the first mobile station 105 is powered on. Alternatively, the first mobile station 105 may instead be awoken from a sleep mode. Next, the first mobile station 105 transmits specific payload packets to the radio access network 115 at operation 255. Finally, at operation 260, the first mobile station 105 indicates that the radio access network 115 is to forward certain of the payload packets to e.g., the target mobile station 110, upon detection of specified triggering events such as a unique combination of the identifiers discussed above with respect to FIGS. 1 and 2. This information transmitted by the first mobile station 105 may be stored in the memory 125.

The various embodiments discussed above may reduce setup delay by about 15% or 150 msec relative to delivery of an invite to, e.g., a PTT communication over the standard traffic channel. These embodiments also eliminate about 20% of messaging associated with the first mobile station 105 updating the presence server 130. The embodiments discussed above are equally application to Institute of Electrical and Electronics Engineers (“IEEE”) 802.16e, High Rate Packet Data (“HRPD”), Code-Division Multiple Access 2000 1X (“CDMA2000 1X”) and Universal Mobile Telecommunications System (“UMTS”).

Accordingly, pursuant to these various embodiments, a system, method, and apparatus are provided that allow for a faster transmission of critical resource information from a mobile station to a radio access network or any other type of wireless network with minimal bandwidth. The mobile station may provide a server of or in communication with the radio access network with a list of pre-selected triggering events that will cause the radio access network to, e.g., transmit a pre-selected packet to a target device such as a target mobile station.

Upon power up of the mobile station, the mobile station may transmit to the server a list of the triggering events and the associated packets to be transmitted or other actions to implement upon detection of one of the triggering events. The triggering events may comprise a unique combination of certain characteristics of a communication from the mobile station to the radio access network such as a pre-selected initial ranging code, a pre-selected bandwidth request size, a pre-selected timing offset, a pre-selected base station location, a pre-selected time of day, a pre-selected timing for the initial ranging code, use a pre-selected media access control MAC ID, a detection of a page response, a detection of a registration, use of a pre-selected frequency band, and detection that the radio access network has received a pre-selected packet.

The predetermined function may comprise at least one of a transmission of a first pre-selected packet between the radio access network and the mobile station, transmission of a second pre-selected packet from the radio access network to a network, a deletion of a third pre-selected packet, an establishment of a first radio link, and a termination of a second radio link.

Accordingly, the mobile station may program the radio access network to implement a “macro,” i.e., a pre-selected combination of criteria that instruct the radio access network to perform some act. By utilizing such macros, the mobile station can more quickly enter into a Push To Talk (“PTT”) or other mobile-to-mobile communication with a target mobile station.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method, comprising:
transmitting, from a mobile station to a radio access network, identifying information relating to the mobile station;
associating the identifying information with a predetermined function; and
performing the predetermined function in response to the associating of the identifying information with the predetermined function.

2. The method of claim 1, the predetermined function comprising at least one of a transmission of a first pre-selected packet between the radio access network and the mobile station, transmission of a second pre-selected packet from the radio access network to a network, a deletion of a third pre-selected packet, an establishment of a first radio link, and a termination of a second radio link.

3. The method of claim 2, wherein the network is at least one of an Internet and another radio access network.

4. The method of claim 1, the identifying information comprising at least one of a pre-selected initial ranging code, a pre-selected bandwidth request size, a pre-selected timing offset, a pre-selected base station location, a pre-selected time of day, a pre-selected timing for the initial ranging code, use a pre-selected media access control (“MAC”) Identifier (“ID”), a detection of a page response, a detection of a registration, use of a pre-selected frequency band, and detection that the radio access network has received a pre-selected packet.

5. The method of claim 1, further comprising the mobile station providing the radio access network with at least one of
a first packet to be forwarded in response to detection of the identifying information, and
a second packet to be compared with at least one incoming packet to the radio access network.

6. The method of claim 1, further comprising the mobile station providing radio access network with a first packet and a 2nd packet, wherein the radio access network waits for a packet from the network to match the first packet, and in response to determining that the packet from the network matches the first packet, the radio access network forwards the second packet to the network.

7. The method of claim 1, wherein the radio access network uses a radio link message to convey that it has completed performing a particular reaction in response to a particular trigger as instructed by the mobile station.

8. The method of claim 1, further comprising transmitting, by the radio access network, at least one of a presence update and an invite.

9. The method of claim 1, wherein the radio network transmits a Radio Frequency (“RF”) loss indication packet in response to detection that an RF link of the mobile station has been dropped.

10. The method of claim 1, wherein an application server on the radio access network transmits a packet for the mobile station.

11. The method of claim 10, wherein the application server learns of a Radio Frequency (“RF”) event from at least one of a presence source within the radio access network, and a signaling message from the radio access network.

12. The method of claim 1, the method further including, in response to the performing of the predetermined function, transmitting, from the radio access network to the mobile station, a message indicating a completion of the predetermined function.

13. A system, comprising:
a mobile station to transmit identifying information relating to the mobile station;
a radio access network to receive the identifying information from the mobile station;
a server in communication with the radio access network to associate the identifying information with a predetermined function; and
a transmission element to perform the predetermined function in response to the associating of the identifying information with the predetermined function.

14. The system of claim 13, further comprising a memory to store the identifying information, the identifying information comprising at least one of a pre-selected initial ranging code, a pre-selected bandwidth request size, a pre-selected timing offset, a pre-selected base station location, a pre-selected time of day, a pre-selected timing for the initial ranging code, use a pre-selected media access control (“MAC”) Identifier (“ID”), a detection of a page response, a detection of a registration, use of a pre-selected frequency band, and detection that the radio access network has received a pre-selected packet.

15. The system of claim 13, wherein the predetermined function comprises at least one of a transmission of a first pre-selected packet between the radio access network and the mobile station, transmission of a second pre-selected packet from the radio access network to a network, a deletion of a third pre-selected packet, an establishment of a first radio link, and a termination of a second radio link.

16. The system of claim 13, the radio access network comprising a presence server to store a status of the mobile station.

17. A radio access network, comprising:
a reception element to receive, from a mobile station, identifying information relating to the mobile station;
a server to associate the identifying information with a predetermined function; and
a transmission element to perform the predetermined function in response to the associating of the identifying information with the predetermined function.

18. The radio access network of claim 17, further comprising a memory to store the identifying information, the identifying information comprising at least one of a pre-selected initial ranging code, a pre-selected bandwidth request size, a pre-selected timing offset, a pre-selected base station location, a pre-selected time of day, a pre-selected timing for the initial ranging code, use a pre-selected media access control (“MAC”) Identifier (“ID”), a detection of a page response, a detection of a registration, use of a pre-selected frequency band, and detection that the radio access network has received a pre-selected packet.

19. The radio access network of claim 17, wherein the predetermined function comprises at least one of a transmission of a first pre-selected packet between the radio access network and the mobile station, transmission of a second pre-selected packet from the radio access network to a network, a deletion of a third pre-selected packet, an establishment of a first radio link, and a termination of a second radio link.

20. The radio access network of claim 17, further comprising a presence server to store a status of the mobile station.
